(19) United States
(12) Patent Application Publication
(10) Pub. No.: US 2004/0037541 A1
(43) Pub. Date: Feb. 26, 2004

(54) BLDC motor speed control apparatus and method

(75) Inventor: Suk-Gyun Han, Seongnam-City (KR)

Correspondence Address: STAAS & HALSEY LLP, SUITE 700, 1201 NEW YORK AVENUE, N.W., WASHINGTON, DC, 20005, US

(73) Assignee: SAMSUNG Electronics Co., Ltd., Suwon-City (KR)

(21) Appl. No.: 10/627,723

(22) Filed: Jul. 28, 2003

(30) Foreign Application Priority Data
Aug. 26, 2002 (KR) 2002-50638

(51) Int. Cl. H02P 5/00

(52) U.S. Cl. 388/800

(57) ABSTRACT

A sensorless speed control apparatus and method for a brushless dc (BLDC) motor. A speed detection unit detects fluxes of respective phases of the BLDC motor, measures a period of the detected flux changes, and determines a speed of the BLDC motor. A subtractor subtracts an inputted reference speed and the detected speed outputted from the speed detection unit, and outputs an error speed. A speed controller outputs a reference current corresponding to the error speed outputted from the subtractor. A current controller outputs a control signal for controlling the switching operations of an inverter based on the reference current outputted from the speed controller. The inverter applies a current of variable frequency to the respective phases of the motor based on the control signal outputted from the current controller, and drives the motor.

### CROSS-REFERENCE TO RELATED APPLICATIONS

This application claims the benefit of Korean Application No. 2002-50638, filed Aug. 26, 2002, in the Korean Intellectual Property Office, the disclosure of which is incorporated herein by reference.

### BACKGROUND OF THE INVENTION

1. Field of the Invention

The present invention relates to sensorless brushless dc (BLDC) motor speed control apparatus and method, and more particularly to sensorless BLDC motor speed control apparatus and method capable of detecting and controlling a speed based on a period of flux rate changes of two transformed phases.

2. Description of the Related Art

In general, a BLDC motor speed control apparatus detects a motor rotor position using a hall sensor and a hall sensor driver, and determines a rotor speed from the detected position.

There is a method using the motor back EMF as an example of a sensorless speed control apparatus, but it has a problem in that its structure is complicated.

As another example of the sensorless speed control apparatus, there is a method disclosed in U.S. Pat. No. 6,377,018 that detects electromagnetic flux components occurring in windings upon motor rotations, and calculates an angular velocity of a rotor to control a motor speed.

The speed control method disclosed in the above patent is implemented with a simple structure, but has a problem in that it can be applied to ac motors, such as induction motors, but not to BLDC motors.

FIG. 1 is a block diagram for schematically showing a structure of a conventional speed control apparatus for a 3-phase BLDC motor using a sensor.

As shown in FIG. 1, the conventional speed control apparatus for a BLDC motor has a sensor 102, a driver 104, a position detector 106, a speed detector 108, a subtractor 110, a speed controller 112, a current controller 114, and a 3-phase inverter 116.

The sensor 102 detects a phase of an induced current of a motor 100. The driver 104 drives the sensor 102 and outputs the detected phase of the induced current to the position detector 106. The position detector 106 detects a motor rotor position from a phase signal of an induced current inputted from the driver 104, and outputs the detected position to the speed detector 108 and the current controller 114. The speed detector 108 detects a driving speed of the motor based on motor rotor position information detected from the position detector 106. The subtractor 110 detects an error speed between an inputted reference speed and the detected speed. The speed controller 112 outputs a variable reference current (current magnitude) based on an error speed value outputted from the subtractor 110. The current controller 114 outputs a control signal for controlling a switching time based on the reference current inputted from the speed controller 112 and a signal inputted from the position detector 106. The 3-phase inverter 116 drives the motor 100 with a current of variable frequency based on a modulated signal depending upon a switching control signal outputted from the current controller 114.

The BLDC motor speed control apparatus having such a structure uses a hall sensor and a hall sensor driver, causing a problem that such an appartus has a complicated structure and a high manufacturing cost, and further, such an appartus can not detect a motor rotor position when current flows in all three phases.

### SUMMARY OF THE INVENTION

To solve the above and/or other problems, it is an aspect of the present invention to provide apparatus and method capable of detecting and controlling a BLDC motor speed without a sensor as a constituent thereof.

To achieve the above and/or other aspects, a BLDC motor speed control apparatus according to an embodiment of the present invention has: a speed detection unit, to determine fluxes of respective phases of currents driving the BLDC motor, to determine a period of the deteremined flux changes, and to determine a speed of the BLDC motor; a subtractor to subtract an inputted reference speed and the detected speed outputted from the speed detection unit, and output an error speed; a speed controller to output a reference current corresponding to the error speed outputted from the subtractor; a current controller to output a switching control signal based on the reference current outputted from the speed controller; and an inverter to drive the BLDC motor with a current of variable frequency, based on the switching control signal outputted from the current controller.

According to one aspect, the speed detection unit has: a flux detection unit to determine fluxes based on induced voltages and currents of windings corresponding to the respective phases of the BLDC motor; and a speed calculation unit to determine specific periods of the fluxes of the respective phases outputted from the flux detection unit, and to calculate a speed of the BLDC motor.

According to one aspect, the flux detection unit has: a current detector to determine the induced voltages and currents corresponding to the respective phases of the current driving the BLDC motor; a phase transformer to transform the induced voltages and currents of the respective phases into induced voltages and currents of two transformed phases; and a flux determination unit to determine the fluxes based on the induced voltages and currents of the first and second phases outputted from the phase transformer.

According to one aspect, the speed calculation unit has: a timer to determine a period during which the fluxes of the respective phases outputted from the flux determination unit become a specific value; and a speed determination unit to determine a rotation speed of the motor based on the period outputted from the timer.

To achieve the above and/or other aspects, a brushless DC (BLDC) motor speed control method according to an embodiment of the present invention comprises: determining a speed of a BLDC motor based on a period in which flux values of respective phases of a current driving the BLDC motor become a specific value; determining an error speed based on an inputted reference speed and the detected speed; outputting a reference current corresponding to the determined error speed; outputting a switching control signal to drive the motor based on the outputted reference current; and driving the motor with a current of variable frequency based on the switching control signal.

Additional aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiment taken in conjunction with the accompanying drawings, in which:

FIG. 1 is a block diagram for schematically showing a structure of a conventional speed control apparatus for a 3-phase BLDC motor;

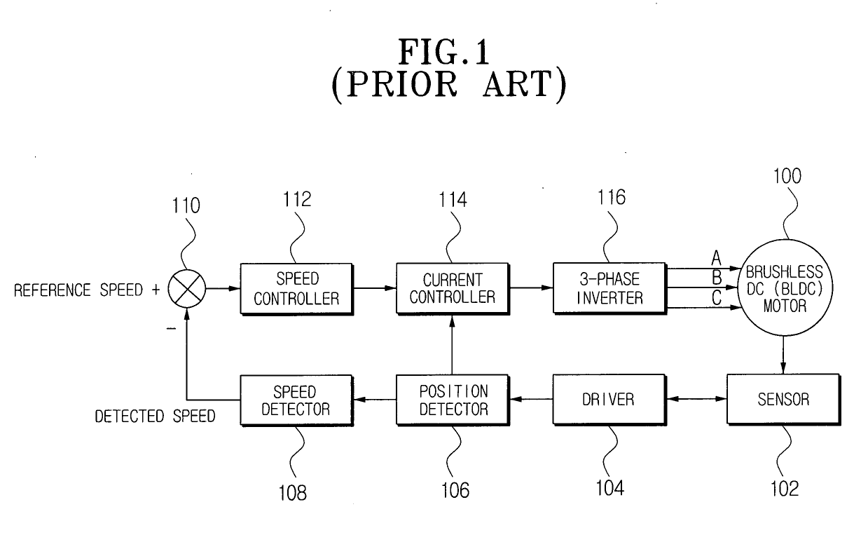

FIG. 2 is a block diagram for schematically showing a structure of a 3-phase BLDC motor speed control apparatus according to an embodiment of the present invention;

FIG. 3 is waveforms for showing flux changes, in radian, in respective phase windings, which are outputted from the flux determination unit of FIG. 2;

FIG. 4 is a flow chart for explaining the operations of the 3-phase BLDC motor speed control apparatus according to an embodiment of the present invention; and

FIG. 5 is a flow chart for explaining in more detail the operations of the speed detection operation of FIG. 4.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the Figures.

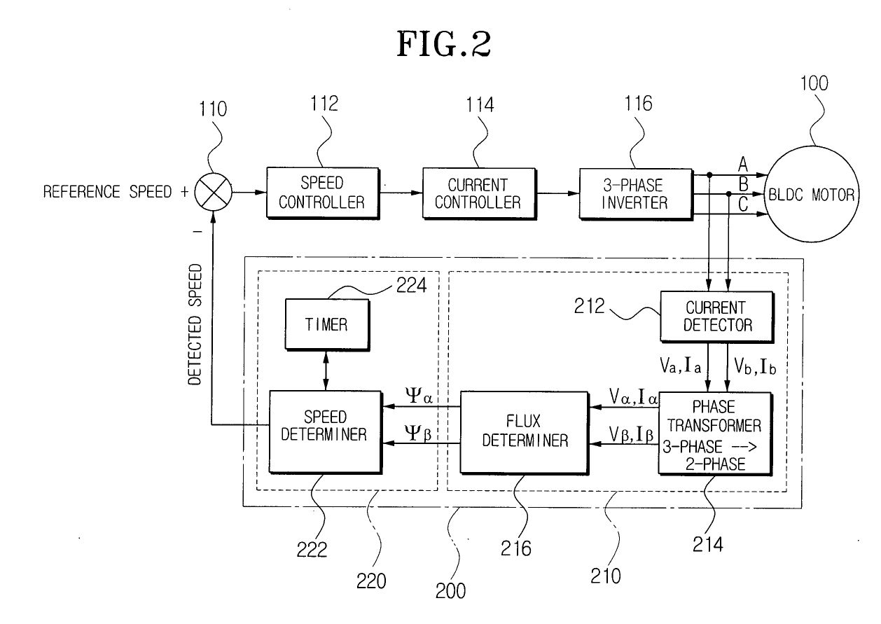

FIG. 2 is a block diagram for schematically showing a structure of a 3-phase BLDC motor speed control apparatus according to an embodiment of the present invention.

As shown in FIG. 2, the present invention has a speed determination unit 200, a subtractor 110, a speed controller 112, a current controller 114, and a 3-phase inverter 116.

The speed determination unit 200 detects fluxes in respective phase windings from induced currents and voltages outputted to the BLDC motor 100 from the 3-phase inverter 116, measures specific periods of the detected fluxes, and detects an angular velocity of a rotor of the BLDC motor 100.

The subtractor 110 performs the subtraction of an inputted reference speed and a speed detected from the speed determination unit 200 and outputs an error speed.

The speed controller 112 outputs a reference current corresponding to the error speed outputted from the subtractor 110.

The current controller 114 outputs a switching control signal for controlling the switching operations of the 3-phase inverter 116 based on the reference current outputted from the speed controller 112.

The 3-phase inverter 116 applies a current of variable frequency, based on the switching control signal outputted from the current controller 114, to the respective phases of the dc motor, and drives the BLDC motor 100.

Hereinafter, the operations of the speed determination unit 200 are described in more detail.

The speed determination unit 200 is provided with a flux determination unit 210 to determine fluxes based on induced currents and voltages of the respective phases of the BLDC motor 100, and a speed calculation unit 220, for measuring specific flux periods of the respective phases outputted from the flux determination unit 210 and calculating a speed of the BLDC motor 100.

The flux determination unit 210 has a current detector 212 to detect induced voltages and currents corresponding to two phases of the three phases of the BLDC motor 100, a phase transformer 214 for transforming the induced currents and voltages of the two phases into 2-phase induced voltages and currents, and a flux determiner 216 to determine the fluxes of the respective phases based on the induced voltages and currents of the first and second phases outputted from the phase transformer 214.

Further, the speed calculation unit 220 has a timer 224 for measuring a period that the flux for each phase outputted from the flux determination unit 210 becomes a specific value, and a speed determiner 222 to determine a rotation speed of the BLDC motor 100 based on a period value outputted from the timer 224.

If the current detector 212 of the flux determination unit 210 outputs induced currents Ia and Ib and voltages Va and Vb corresponding to the two phases of the BLDC motor 100, the phase transformer 214 performs 2-phase transform based on Formula Set 1, as shown below.

$$\begin{matrix}Formula Set 1 \\ {V}_{α} = {V}_{a} \\ {V}_{β} = \frac{2 {V}_{b} + {V}_{a}}{\sqrt{3}} \\ {I}_{α} = {I}_{a} \\ {I}_{β} = \frac{2 {I}_{b} + {I}_{a}}{\sqrt{3}}\end{matrix}$$

where, V_{α} and V_{β} respectively indicate induced voltages corresponding to the transformed two phases, I_{α} and I_{β} respectively indicate induced currents corresponding to the transformed two phases, Vₐ and V_{b} respectively indicate voltages induced in two phases of the three phases of the BLDC motor, and Iₐ and I_{b} respectively indicate currents induced in the two phases of the three phases of the motor.

Further, the flux determiner 216 of the flux determination unit 210 determines an Electro-Magnetic flux corresponding to each phase based on Formula Set 2, as shown below depending upon induced two phase voltages V_{α} and V_{β} and currents I_{α} and I_{β} which are inputted from the phase transformer 214.

Formula Set 2

Ψ_{α}=∫(V_{α}−RₛI_{α})dt

Ψ_{β}=∫(V_{β}−RₛI_{β})dt

Where, Ψ_{α} indicates the flux of a first phase, Ψ_{β} indicates the flux of a second phase, V_{α} indicates an induced voltage of the first phase, V_{β} indicates an induced voltage of the second phase, Rₛ indicates the winding resistance of the motor, I_{α} indicates an induced current of the first phase, and I_{β} indicates an induced current of the second phase.

The speed calculation unit 220 measures time intervals between when each of the fluxes of the two phases outputted from the flux determination unit 210 respectively become ‘0’, and detects a speed of the BLDC motor 100 based on the measured period.

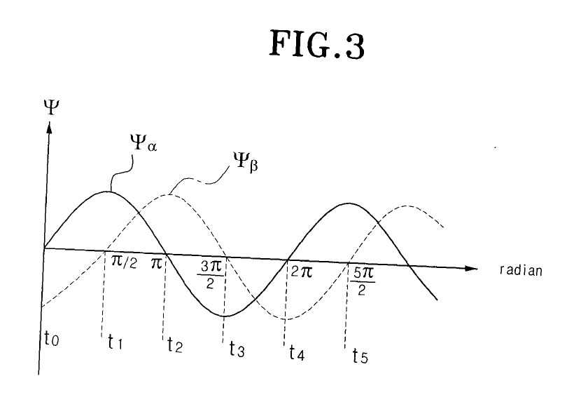

The operations of the speed calculation unit 220 are described in detail with reference to FIG. 3.

FIG. 3 depicts waveforms, in radians, to show flux changes of the respective phases outputted from the flux determination unit 210 of FIG. 2.

As shown in FIG. 3, Ψ_{α} and Ψ_{β} outputted from the flux determination unit 210 indicates sinusoidal waveforms with a phase difference of 90°.

The timer 224 of the speed calculation unit 220 measures time intervals amongst timings at which Ψ_{α} or Ψ_{β} becomes ‘0’. As shown in FIG. 3, Ψ_{α} becomes ‘0’ at t0, t2, and t4, and Ψ_{β} becomes ‘0’ at t1, t3, and t5. Accordingly, the minimum period T₀ that Ψ_{α} or Ψ_{β} becomes 0′ is tn−t(n−1).

The speed determiner 222 of the speed calculation unit 220 determines an angular velocity of the BLDC motor 100 from T₀ outputted from the timer 224 and Ψ_{α} and Ψ_{β} based on Formula Set 3, as shown below.

$$ω = \frac{π}{2 {T}_{0}} [ radian \text{/} sec ]$$

Where T₀ denotes a time interval during which both of the fluxes of the two phases becomes ‘0’, and ω denotes an angular velocity of a rotor of the BLDC motor 100.

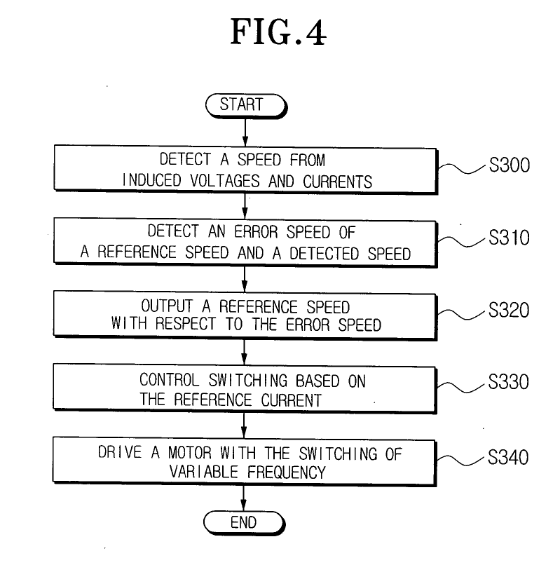

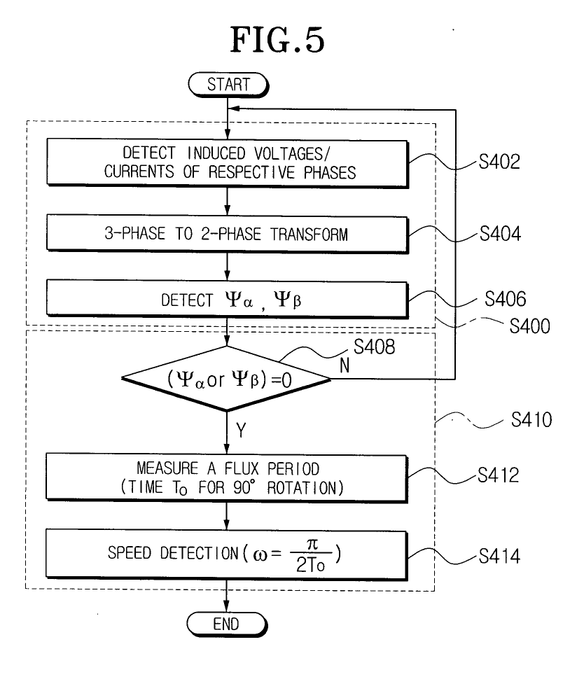

Hereinafter, a BLDC motor speed control method according to the present invention is described with reference to FIG. 4 and FIG. 5. FIG. 4 is a flow chart for explaining the operations of the speed control apparatus for a 3-phase BLDC motor according to an embodiment of the present invention.

First, in operation S300, the speed determination unit 200 determines fluxes of the respective phases from induced currents and voltages outputted to the BLDC motor 100 from the 3-phase inverter 116, measures specific periods of the determined fluxes, and determines an angular velocity of a rotor of the BLDC motor 100.

Then, in operation S310, the subtractor 110 subtracts an inputted reference speed and a detected speed outputted from the speed determination unit 200 and outputs an error speed.

In operation S320, the speed controller 112 outputs a reference current corresponding to the error speed outputted from the subtractor 110.

Next, in operation S330, the current controller 114 outputs a control signal to control the switching operations of the 3-phase inverter 116 based on the reference current outputted from the speed controller 112.

Finally, in operation S340, the 3-phase inverter 116 applies a current of variable frequency to the motor, based on the control signal outputted from the current controller 114, to drive the BLDC motor 100.

FIG. 5 is a flow chart for explaining in more detail the operations in the speed detection operation (S300) of FIG. 4.

First, in operation S400, the flux determination unit 210 determines fluxes based on induced voltages and currents corresponding to the respective phases of the BLDC motor 100.

Next, in operation S410, the speed calculation unit 220 measures specific periods of flux changes corresponding to the respective phases outputted from the flux determination unit 210, and calculates a speed of the BLDC motor 100.

The flux determination operation S400 includes the following operations.

First, in operation S402, the current detector 212 detects induced voltages and currents corresponding to two of the three phases of the BLDC motor 100.

Then, in operation S404, the phase transformer 214 transforms induced voltages and currents of the two phases into induced 2-phase voltages and currents through the 2-phase transform operations based on Formula 1.

Finally, in operation S406, the flux determiner 216 determines the fluxes of the respective phases based on the induced voltages and currents of the first and second phases outputted from the phase transformer 214 based on Formula 2.

The speed determination operation S410 includes the following operations.

First, in operation S408 and S412, the timer 224 of the speed calculation unit 220 measures periods in which the fluxes of the respective phases outputted from the flux determination unit 210 become specific values. That is, the timer 224 measures a time interval between when Ψ_{α} and Ψ_{β} become ‘0’. As shown in FIG. 3, the times at which Ψ_{α} becomes ‘0’ are t0, t2, and t4, and the times at which Ψ_{β} becomes ‘0’ are t1, t3, and t5. Accordingly, the minimum period T₀ between when Ψ_{α} and Ψ_{β} become ‘0’ is tn−t(n−1).

Finally, in operation S414, the speed determiner 222 of the speed calculation unit 220 determines an angular velocity of the BLDC motor 100 from Ψ_{α} and Ψ_{β} based on T₀ outputted from the timer 224 and Formula 3.

The BLDC motor speed control apparatus and method according to an embodiment of the present invention can be simplified in structure relative to other BLDC motor speed control apparatuses, to determine and control a BLDC motor speed without a speed sensor and its driver.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A brushless dc (BLDC) motor speed control apparatus, comprising:
a speed determination unit to determine fluxes of respective phases of currents driving a three phase BLDC motor, measure a period of the determined flux changes, and determine a speed of the BLDC motor;
a subtractor to subtract an inputted reference speed and the determined speed outputted from the speed determination unit, and output an error speed;
a speed controller to output a reference current corresponding to the error speed outputted from the subtractor;
a current controller to output a switching control signal based on the reference current outputted from the speed controller; and
an inverter to drive the BLDC motor with a current of variable frequency based on the switching control signal outputted from the current controller.

2. The apparatus as claimed in claim 1, wherein the speed determination unit comprises:
a flux determination unit to determine fluxes based on induced voltages and currents of windings corresponding to the respective phases of the BLDC motor; and
a speed calculation unit to measure specific periods of the fluxes of the respective phases outputted from the flux determination unit, and determine a speed of the BLDC motor.

3. The apparatus as claimed in claim 2, wherein the flux determination unit comprises:
a current detector to detect the induced voltages and currents corresponding to the respective phases of the current driving the BLDC motor;
a phase transformer to transform the induced voltages and currents of the respective phases into induced voltages and currents of first and second transformed phases; and
a flux determiner to determine the flux based on the induced voltages and currents of the first and second transformed phases outputted from the phase transformer.

4. The apparatus as claimed in claim 3, wherein:
the phase transformer transforms the three phases of the BLDC motor into two phases employing the formulas:
$$\begin{matrix}{V}_{α} = {V}_{a} \\ {V}_{β} = \frac{2 {V}_{b} + {V}_{a}}{\sqrt{3}} \\ {I}_{α} = {I}_{a} \\ {I}_{β} = \frac{2 {I}_{b} + {I}_{a}}{\sqrt{3}}\end{matrix}$$
where, V_{α} and V_{β} respectively indicate induced voltages corresponding to the first and second transformed phases, I_{α} and I_{β} respectively indicate induced currents corresponding to the first and second transformed phases, Vₐ and V_{b} respectively indicate voltages induced in two phases of the three phases of the BLDC motor, and Iₐ and I_{b} respectively indicate currents induced in the two phases of the three phases of the motor.

5. The apparatus as claimed in claim 3, wherein:
the flux determiner determines fluxes with respect to the first and second transformed phases employing the formulas:
Ψ_{α}=∫(V_{α}−RₛI_{α})dt
Ψ_{β}=∫(V_{β}−RₛI_{β})dt
where, Ψ_{α} indicates the flux of the first transformed phase, Ψ_{β} indicates the flux of the second transformed phase, V_{α} indicates an induced voltage of the first transformed phase, V_{β} indicates an induced voltage of the second transformed phase, Rₛ indicates the winding resistance of the motor, I_{α} indicates an induced current of the first transformed phase, and I_{β} indicates an induced current of the second transformed phase.

6. The apparatus as claimed in claim 5, wherein the speed calculation unit comprises:
a timer to measure a period during which the fluxes of the first and second transformed phases outputted from the flux determiner become a predetermined value; and
a speed determiner to determine a rotation speed of the BLDC motor based on the period outputted from the timer.

7. The apparatus as claimed in claim 6, wherein:
the speed determiner measures a time interval during which both of the fluxes of the first and second transformed phases become ‘0’.

8. The apparatus as claimed in claim 7, wherein the speed determiner determines the speed employing the formula:
$$ω = \frac{π}{2 {T}_{0}} [ radian / sec ]$$
where T₀ denotes the time interval during which both of the fluxes of the first and second transformed phases become ‘0’, and ω denotes an angular velocity of the BLDC motor.

9. A brushless DC (BLDC) motor speed control method, comprising:
determining a speed of a BLDC motor based on a period in which flux values of respective phases of a current driving the BLDC motor become a specific value;
determining an error speed based on an inputted reference speed and the determined speed;
outputting a reference current corresponding to the determined error speed;
outputting a switching control signal to drive the motor based on the outputted reference current; and
driving the motor with a current of variable frequency based on the switching control signal.

10. The method as claimed in claim 9, wherein the determining the speed of the BLDC motor based on the period in which flux values of the respective phases of the current driving the BLDC motor become the specific value comprises:
determining fluxes corresponding to the respective phases of the current driving the BLDC motor; and
determining a speed of the BLDC motor based on a time interval during which both of the respective determined fluxes becomes ‘0’.

11. The method as claimed in claim 10, wherein the determining fluxes corresponding to the respective phases of the current driving the BLDC motor comprises:
determining voltages and currents induced in two phases of three phases of the BLDC motor;
transforming the determined voltages and currents induced in the two phases into voltages and currents of first and second transformed phases; and
determining fluxes of the first and second transformed phases.

12. The method as claimed in claim 11, wherein:
the transforming the determined voltages and currents induced in the two phases into the voltages and currents of the first and second transformed phases employs the formulas:
$$\begin{matrix}{V}_{α} = {V}_{a} \\ {V}_{β} = \frac{2 {V}_{b} + {V}_{a}}{\sqrt{3}} \\ {I}_{α} = {I}_{a} \\ {I}_{β} = \frac{2 {I}_{b} + {I}_{a}}{\sqrt{3}}\end{matrix}$$
where, V_{α} and V_{β} respectively indicate induced voltages corresponding to the two transformed phases, I_{α} and I_{β} respectively indicate induced currents corresponding to the two transformed phases, Vₐ and V_{b} respectively indicate voltages induced in two phases of the three phases of the BLDC motor, and Iₐ and I_{b} respectively indicate currents induced in the two phases of the three phases of the motor.

13. The method as claimed in claim 12, wherein:
the determining the fluxes of the first and second transformed phases employs the employs the formulas:
Ψ_{α}=∫(V_{α}−RₛI_{α})dt
Ψ_{β}=∫(V_{β}−RₛI_{β})dt
where, Ψ_{α} indicates the flux of the first transformed phase, Ψ_{β} indicates the flux of the second transformed phase, V_{α} indicates an induced voltage of the first transformed phase, V_{β} indicates an induced voltage of the second transformed phase, Rₛ indicates the winding resistance of the motor, I_{α} indicates an induced current of the first transformed phase, and I_{β} indicates an induced current of the second transformed phase.

14. The method as claimed in claim 13, wherein:
the determining the speed of the BLDC motor employs the formula:
$$ω = \frac{π}{2 {T}_{0}} [ radian \text{/} sec ]$$
where, T₀ denotes a time interval during which both of the fluxes of the two transformed phases becomes ‘0’, and ω denotes an angular velocity of the BLDC motor.

15. A speed determination unit for a brushless dc (BLDC) motor speed control apparatus, comprising:
a flux determination unit to determine fluxes based on induced voltages and currents of windings corresponding to two phases of three phases of the BLDC motor; and
a speed calculation to determine specific periods of the fluxes of the respective phases outputted from the flux determination unit and calculating a speed of the BLDC motor.

16. The apparatus as claimed in claim 15, wherein the flux determination unit comprises:
a current detector to detect the induced voltages and currents corresponding to the two phases of the three phases of the current driving the BLDC motor;
a phase transformer to transform the induced voltages and currents of the two phases into induced voltages and currents of first and second transformed phases; and
a flux determiner to determine fluxes of the first and second transformed phases based on the induced voltages and currents of the first and second transformed phases outputted from the phase transformer.

17. The apparatus as claimed in claim 16, wherein the speed calculation unit comprises:
a timer to determine a period between when the flux of the first transformed phase becomes a specific value and when the flux of the second transformed phase becomes the specific value; and
a speed determiner to determine a rotation speed of the motor based on the period determined by the timer.

18. The apparatus as claimed in claim 17, wherein the specific value is ‘0’.

19. A speed determination unit for a brushless dc (BLDC) motor speed control apparatus, comprising:
a current detector to detect induced voltages and currents corresponding to two phases of three phases of current driving the BLDC motor;
a phase transformer to transform the induced voltages and currents of the two phases of the three phases into induced voltages and currents of first and second transformed phases;
a flux determiner to determine fluxes of the first and second transformed phases based on the induced voltages and currents of the first and second transformed phases outputted from the phase transformer;
a timer to determine a period between when the flux of the first transformed phase becomes a specific value and when the flux of the second transformed phase becomes the specific value; and
a speed determiner to determine a rotation speed of the motor based on the period determined by the timer.

20. The apparatus as claimed in claim 19, wherein the specific value is ‘0’.

21. A speed determination unit for a brushless dc (BLDC) motor speed control apparatus, wherein:
the speed determination apparatus determines and controls a BLDC motor speed without a speed sensor and a speed sensor driver.
